(19) United States
(12) Patent Application Publication
(10) Pub. No.: US 2014/0012445 A1
(43) Pub. Date: Jan. 9, 2014

(54) Temperature Control Method for an Electrochemical Energy Store in a Vehicle

(71) Applicant: Bayerische Motoren Werke Aktiengesellschaft, Muenchen (DE)

(72) Inventors: Matthias FLECKENSTEIN, Muenchen (DE); Thomas HOEFLER, Groebenzell (DE); Andreas WILDE, Oberhaching (DE); Oliver BOHLEN, Muenchen (DE); Daniel KUHN, Muenchen (DE)

(21) Appl. No.: 13/918,203

(22) Filed: Jun. 14, 2013

Related U.S. Application Data
(63) Continuation of application No. PCT/EP2011/071369, filed on Nov. 30, 2011.

(30) Foreign Application Priority Data
Dec. 17, 2010 (DE) 10 2010 063 376.3

(51) Int. Cl. B60L 11/18

(52) U.S. Cl. CPC B60L 11/1874
USPC 701/22

(57) ABSTRACT

A temperature control method for an electrochemical energy storage device having a cooling device for cooling the storage device in a vehicle. An actual temperature value of the storage device is determined, and a desired temperature value of the storage device is set by a two-point control system, which activates the cooling device at an upper temperature limit of the storage device and deactivates the cooling device at a lower temperature limit. The upper temperature limit and/or the lower temperature limit are defined as a function of time during operation of the storage device or during activation of the cooling device. The upper temperature limit and/or the lower temperature limit are defined as a function of the energy storage device data and/or the vehicle operating data.

### BACKGROUND AND SUMMARY OF THE INVENTION

The invention relates to a temperature control method for an electrochemical energy storage device in a vehicle, wherein the electrochemical energy storage device has a cooling device for the purpose of cooling said electrochemical energy storage device, and wherein an actual temperature value of the electrochemical energy storage device is determined with a temperature measuring means, and a desired temperature value of the electrochemical energy storage device is set by a two-point control system, which activates the cooling device at an upper temperature limit of the electrochemical energy storage device and which deactivates the cooling device at a lower temperature limit of the electrochemical energy storage device.

Electrochemical energy storage devices are becoming increasingly more important in the framework of the progressive electrification of the drive train of vehicles for passenger and freight transport. In particular, secondary energy storage devices in the high voltage range, which are based on the lithium ion cell technology, are the subject of current research and development. Several lithium ion cells are connected in a battery case and form, together with the monitoring and control electronics as well as with a cooling device, the entire system of an electrochemical energy storage device. Since the battery cells exhibit their optimal operating range in a narrow temperature band and are subject to accelerated aging, in particular, at a very high temperature, the system of the electrochemical energy storage device also has a cooling device for the purpose of cooling the cells, so that the cells do not exceed a maximum permissible limit temperature.

According to the prior art, not only air cooling systems, but also liquid cooling systems are used, in which a refrigerant is evaporated by evaporative cooling in a cooling circuit in the electrochemical energy storage device and is condensed in a compression-type refrigerating machine. For example, the document EP 2068390 A1 discloses such a cooling device. When cooling the electrochemical energy storage device, the heat transfer by means of evaporative cooling does not act as a controlled variable. Controlled is only the flow of the refrigerant. As described in the document JP 2001105843 A, this method uses a two-point control system that sets the operating situations: “flow of the refrigerant on” and “flow of the refrigerant off.” For the purpose of cooling a battery, the two-point control system activates a cooling circuit at a preset upper temperature limit and deactivates the cooling circuit at a preset lower temperature limit, so that the temperature of the battery does not exceed a maximum temperature.

The drawback with such a fixed setting of the upper and lower temperature limits is the fact that although the maximum attained temperature of the electrochemical energy storage device during the cooling operation does not exceed the maximum permissible limit temperature of the electrochemical energy storage device, the difference between the maximum, actually achieved temperature and the maximum permissible limit temperature turns out, however, to be unnecessarily large in most operating situations. Therefore, in order not to exceed the maximum limit temperature, the electrochemical energy storage device is operated, averaged over time, as required, at a lower temperature than necessary. Within the preset optimal temperature operating range, electrochemical energy storage devices tend to exhibit a higher energy efficiency at a higher temperature. As a result, the charge and discharge efficiency of the energy storage device according to the prior art is not used in an optimal way. Furthermore, the cooling components exhibit a higher rate of wear and tear.

Therefore, an object of the present invention is to provide an improved temperature control method for an electrochemical energy storage device in a vehicle.

This engineering object is achieved by means of a temperature control method for an electrochemical energy storage device in a vehicle. In this case, the electrochemical energy storage device includes a cooling device for the purpose of cooling said electrochemical energy storage device, and an actual temperature value of the electrochemical energy storage device is determined with a temperature measuring device; and a desired temperature value of the electrochemical energy storage device is set by a two-point control system, which activates the cooling device at an upper temperature limit of the electrochemical energy storage device and which deactivates the cooling device at a lower temperature limit of the electrochemical energy storage device. According to the invention, the upper temperature limit of the two-point control system and/or the lower temperature limit of the two-point control system is and/or are defined as a function of time during operation of the electrochemical energy storage device or during the activation of the cooling device; and the upper temperature limit of the two-point control system and/or the lower temperature limit of the two-point control system is and/or are defined as a function of the energy storage device data and/or the vehicle operating data.

The invention has the advantage that the temperature limits, at which the cooling device is connected to the two-point control system, are not predefined, but rather are variably adjusted as a function of certain operating or environmental conditions. Without exceeding a maximum permissible limit temperature, the cooling capacity can be used more efficiently in comparison to a cooling circuit with fixed switching limits. This feature is reflected, for example, in the fact that under certain operating and environmental situations, the upper temperature limit for activating the cooling device of the electrochemical energy storage device may be shifted in the direction of a higher temperature, so that the temperature profile of the electrochemical energy storage device during the cooling operation shows a smaller minimum difference with respect to the maximum permissible limit temperature. In a different operating situation, it may be advantageous to have performed the deactivation of the cooling device of the electrochemical energy storage device at a higher lower temperature limit, when after switching off the cooling device for some reason, a reduced heat input into the electrochemical energy storage device can be expected.

For example, the energy storage device data and the vehicle operating data can be used for the temperature control method, where both the energy storage device data and the vehicle operating data are stored on at least one control device of the vehicle or a storage medium of the vehicle and are optionally determined with measuring devices in the vehicle or can be determined by calculation or simulation, which is performed on a control device. The data can also be received from a communication device of the vehicle. The energy storage device data and the vehicle operating data serve the temperature control method as the input variables.

It is particularly advantageous to use, in addition to the actual temperature as the input and controlled variable of the electrochemical energy storage device, additional parameters of the electrochemical energy storage device as the input variables. The impending heat input into the electrochemical energy storage device and, thus, the impending cooling capacity requirement can be determined based on the recorded data. With such a prediction it is possible to optimize the use of the cooling capacity and, as a result, to reduce the frequency, at which the system is switched on and switched off. This feature contributes to a longer life of the cooling components. In addition, when the use of the cooling capacity is optimized as a function of the requirements, the result is an operating temperature of the electrochemical energy storage device that is higher when averaged over time. Since the actual temperature of the electrochemical energy storage device according to closed loop control task does not rise above the maximum permissible limit temperature, there is no accelerated aging of the battery cells. Instead, the result is an improvement in the overall energy balance of the energy storage device because of the improved charging and discharging efficiency of the energy storage device over a long period of observation.

According to a preferred embodiment of the present invention, the energy storage device data include a record of the actual temperature value of the electrochemical energy storage device as a function of time, in order to determine a time-dependent temperature gradient from the record of the actual temperature value. The upper temperature limit of the two-point control system and/or the lower temperature limit of the two-point control system is and/or are defined as a function of the time-dependent temperature gradient.

With this procedure, the rate of the temperature profile is included in the control method. For example, at a low rate of temperature increase, at which the cooling device is activated, the upper temperature limit may be shifted in the direction of a higher temperature. At a high rate of temperature increase, it is necessary to activate the cooling device at a lower temperature, so that the maximum permissible limit temperature of the electrochemical energy storage device is not exceeded at any time due to the thermal inertia of the system. This method corresponds to the principle of a differential controller, in order to minimize an overshooting of the controlled variable.

According to an especially preferred embodiment of the invention, the energy storage device data include a time-dependent record of the charge and discharge current of the electrochemical energy storage device and a time-dependent record of the voltage of the electrochemical energy storage device. A time-dependent relative state of charge of the electrochemical energy storage device is determined from the record of the current and the record of the voltage; and the upper temperature limit of the two-point control system and/or the lower temperature limit of the two-point control system is and/or are defined as a function of the time-dependent relative state of charge.

For the operational performance and the wear characteristics of an electrochemical energy storage device it is especially advantageous if the energy storage device is operated not only in a preferred temperature range, but also in a preferred state of charge range. Therefore, it is particularly advantageous to shift both the upper temperature limit for the activation of the cooling device as well as the lower temperature limit for the deactivation of the cooling device in the direction of a higher temperature when the state of charge of the energy storage device is extremely reduced. In the case of a very small state of charge the energy storage device in a vehicle having an electrified drive train can be used only to a limited extent for discharging with high currents, for example, in order to drive the vehicle. In a first approximation, the result of this state is a lower cooling capacity requirement than in the case of a higher state of charge. Furthermore, the increase in the temperature limits leads to an improvement in the charging efficiency. This feature facilitates a rapid increase in the relative state of charge of the energy storage device in the preferred state of charge range.

Furthermore, it may be advantageous to determine a time-dependent internal resistance of the electrochemical energy storage device from the record of the current and from the record of the voltage and to define the upper temperature limit of the two-point control system and/or the lower temperature limit of the two-point control system as a function of the time-dependent internal resistance.

The generation of Joule heat that appears as a loss of current heat during the electrochemical conversion is directly proportional to the internal resistance of the energy storage device. Therefore, it is very important to know the value of the internal resistance for an efficient operation and optimal design of a temperature control system. In the event of a relative change in the internal resistance in the direction of a larger value, the result is a higher heat input into the energy storage device due to the increasing power dissipation. In this case a higher value is obtained due to the integration of the power dissipation over a suitable period of time; and the upper temperature limit and/or the lower temperature limit is and/or are shifted in the direction of the lower temperature.

In addition, the vehicle operating data can include a time-dependent record of an ambient temperature of the vehicle; and the upper temperature limit of the two-point control system and/or the lower temperature limit of the two-point control system can be defined as a function of the ambient temperature.

It is especially advantageous to shift the temperature limits of the cooler circuit in the direction of the smaller temperature values in the case of a high ambient temperature and to shift in the direction of a higher temperature in the case of a low ambient temperature. In the case of a low ambient temperature, the cooling effect of the energy storage device due to heat conduction and/or convection is used specifically at the geometrical location of the housing of the energy storage device, in order to minimize the usage of the cooling capacity of the cooling device.

According to an additional embodiment of the invention, the vehicle operating data include the road profile of an upcoming travel route that is determined by a navigation system of the vehicle. In addition, the vehicle operating data include information about the traffic situation along the upcoming route to be travelled and information concerning the weather forecast at the location of the vehicle and along the upcoming route to be travelled; and both types of information are received from a communication system of the vehicle. The upper temperature limit of the two-point control system and/or the lower temperature limit of the two-point control system is and/or are defined as a function of the characteristic features of the route profile and/or the traffic situation and/or the weather forecast.

The temperature profile of an electrochemical energy storage device is determined, in addition to the internal resistance, in particular, by the amount of charge and discharge currents that occur. The power dissipation due to Joulean heat increases with the square of the battery current. For example, in the case of a vehicle having an electrified drive, this means that an upcoming route that has an above average number of curves or slopes will have an above average number of discharge phases with a high discharge current. The resulting high heat input into the energy storage device is counteracted by a shift of the temperature limits for the activation and deactivation of the cooling device in the direction of the smaller temperature values. If it can be determined from the traffic situation on the upcoming route to be travelled that the frequent stop and go driving actions that occur, for example, in traffic jams or in the event of a high volume of traffic will result in a higher heat input into the energy storage device while travelling on the route, then the temperature limits are also shifted in the direction of the smaller values. Characteristic features of the weather forecast along an upcoming route to be travelled or at the location of the vehicle should also be considered advantageous. If, for example, precipitation is forecast along a route to be travelled, experience has shown that a lower average speed can be expected, a feature that is associated, for example, in a vehicle having an electrified drive, with a smaller heat input into the energy storage device. Hence, the temperature limits for the cooling circuit can be shifted in the direction of higher values.

The vehicle operating data can also include information about a user behavior that characterizes a particular driver of the vehicle, wherein the driver is identified by an identification device in the vehicle. The user behavior of a particular driver is determined from the record of the charge and discharge current of the electrochemical energy storage device or from a record of the acceleration and deceleration values of the vehicle over a long observation period. The upper temperature limit of the two-point control system and/or the lower temperature limit of the two-point control system is and/or are defined as a function of the characteristic features of the user behavior of a particular driver.

This embodiment is especially advantageous in that the driver-specific features that result in a specific loading profile for the energy storage device are considered in determining the temperature limit for the cooling circuit. A specific driver can be identified with the vehicle by using a suitable interface, such as with a specific electronic key or by a man-machine input into the communication unit in the vehicle. On identifying a driver, of whom the characteristics of his user behavior are stored and who is characterized, for example, as extremely dynamic, that means that he very often performs extreme acceleration or braking actions, for example, which lead to a high heat input into the energy storage device, the temperature limits for the cooling device are shifted in the direction of the lower temperature.

The invention is based on the considerations presented below. The battery cells of lithium ion technology exhibit their optimal operating range only in a limited temperature band that is defined by the efficiency of the cells and the aging rate of the cells. Lithium ion battery cells are ideally operated in electrochemical energy storage devices in a temperature range between +5 degrees Celsius and +40 degrees Celsius. As the temperature increases, these battery cells usually show better efficiency, but have a tendency to age faster above a maximum permissible limit temperature. A uniform operation of the cells at a high temperature, but below the maximum permissible limit temperature is advantageous in terms of their efficiency. Therefore, it is necessary to control the temperature when such battery cells are used to operate electrochemical energy storage devices, especially if they are used in a vehicle with an electrified drive.

In order to implement this temperature control, on the one hand, as precisely as possible and, on the other hand, as efficiently as possible, both the detection of the actual thermal state of the battery cells and an associated control strategy play a key role. In order to implement the temperature control function of the battery, a liquid cooling device is often used in the prior art because of the high performance. A liquid cooling device is usually not designed as a continuous variable temperature control system. As a result, the dissipation of the heat from the battery cells to the cooling medium is not directly controllable. Only the operating state of the cooling circuit (in operation and out of operation) can be switched. The temperature control during cooling and heating of the battery cells with temperature control systems that are not infinitely variable is carried out, as well-known from the prior art, with a two-point control system. In this case a measured temperature of the battery cell is usually used as a control variable. For the cooling process a two-point control system means that when a specified setpoint temperature of the battery cell is exceeded, the cooling device is switched on; and when a specified setpoint temperature of the battery cells is undershot, the cooling device is switched off again.

The implementation of the cooling process according to the prior art is associated with the following disadvantages. In past systems with a two-point control system that has fixed on and off threshold values, the tendency is usually to select too large a temperature difference between the maximum permissible limit temperature of the battery cell and the switch-on temperature of the cooling device, so that a thermal safety distance is maintained for all driving and ambient conditions, in order not to exceed the maximum limit temperature, even under critical conditions. As a result, the battery cells are operated in a lower and, thus, more inefficient temperature range. The associated increase in the amount of effort required to achieve cooling leads to a higher frequency in switching on and off the cooling circuit, a feature that increases the wear of the cooling circuit components and additionally reduces the efficiency of the storage device.

The following measure is proposed in order to eliminate the disadvantages of the prior art. In the two-point temperature control system of an electrochemical energy storage device with a liquid cooling device and determination of the temperature of the battery cells, the switching parameters of the cooling device are shifted as a function of the vehicle signals and the signals of the storage device. The following advantages are achieved with the described variation of the switching temperatures. The cooling operation of the cells is performed with a higher degree of accuracy and leads to a temperature profile of the battery cells that is more homogeneous and warmer over time. Therefore, the energy storage device is operated more efficiently without increasing the risk of exceeding the maximum permissible limit temperature at the expense of accelerated aging. The run time of the cooling device can be reduced, a feature that also increases the energy efficiency of the vehicle. Performance restrictions of the energy storage device owing to too high a temperature are avoided, since extreme loads are predicted. The reduced number of switch-on and switch-off events of the cooling device leads to a slower rate of wear of the cooling circuit components. A preconditioning for extreme loads and for stationary phases as a function of (weather-related) environmental influences prevents or rather reduces the operation or the storage of the battery cells at temperatures that are critical for the aging process.

### DETAILED DESCRIPTION OF A PREFERRED EMBODIMENT

A preferred exemplary embodiment of the invention will be described below. Additional details, preferred embodiments and further developments of the invention will become apparent from this description.

In a two-point control system for cooling an electrochemical energy storage device with lithium ion cells, the time-dependent actual temperature of a battery cell is measured with a temperature sensor; and this time-dependent actual temperature, which is referred to as T_{actual}(t), is used as a control and observation variable. In this case it involves a measurement at a position of a representative cell of the entire energy storage device that is in close vicinity to a cell terminal. A desired temperature value at this measurement location is achieved in that the cooling device in the form of a cooling circuit with an evaporating refrigerant and a refrigerant compressor is activated at an upper temperature limit, referred to herein as T_{oG}, and is deactivated at a lower temperature limit, which is referred to herein as T_{uG}. Furthermore, the time-dependent voltage of the energy storage device, which is referred to herein as U(t), is measured with a high ohmic resistance; and the current of the energy storage device, which is referred to herein as I(t), is measured with a low ohmic resistance, in order to determine an internal resistance or an impedance, which is referred to herein as R(t). In the simplest approximation, this can be done according to Ohm's law. In addition, a relative state of charge, referred to herein as SoC(t), is determined by measuring the open circuit voltage of the energy storage device and by a time-dependent integration of the current. Joule's power dissipation, referred to herein as Pᵥ(T), can be estimated according to Pᵥ(t)=R(t)·I(t)². The introduced energy storage device data U(t), I(t), SoC(t), R(t) and Pᵥ(t) are stored, for example, on a control device.

The temperature limits for switching the cooling device can be varied as a function of the recorded data of the energy storage device. For example, it is possible to specify a change in the upper temperature limit in comparison with a previously determined value, wherein the change is referred to herein as ΔT_{oG}, which depends on the temperature profile of the energy storage device. With the actual temperature gradient \dot{T}_{actual}(t), which is given by the first derivative of the actual temperature according to the time, ΔT_{oG}∝−\dot{T}_{actual}(t) holds true for the change. That is, at an increasing rate of the temperature rise, the upper temperature limit T_{OG} is shifted in the direction of a lower temperature value. Therefore, at an increasing rate of the temperature drop during the cooling process, the lower temperature limit may be shifted in the direction of a higher temperature value in accordance with ΔT_{uG}∝−\dot{T}_{actual}(t). If the relative state of charge falls below a predetermined limit value of the state of charge, which is referred to herein as SoC_{G}, meaning that the energy storage device is over-discharged, then the upper temperature limit can be raised in accordance with ΔT_{oG}∝+(SoC_{G}−SoC(t)). Similarly the lower temperature limit can be raised in accordance with ΔT_{uG}∝+(SoC_{G}−SoC(t)). In the event that the state of charge is extremely low, the energy storage device generally exhibits a declining demand for cooling performance. Furthermore, the charging of the energy storage device is supported in the medium state of charge range, which is above the state of charge limit value, by raising the temperature limits in order to achieve an improvement in the charge acceptance ability of the energy storage device. Even the estimated power dissipation Pᵥ(t) can be used to vary the temperature limits for switching the cooling device. For example, the upper temperature limit can be changed according to ΔT_{oG}∝−∫^{t}_{t-Δt}Pᵥdt, where Δt denotes a specific time interval before the current time t. If expressed in other words, the greater the entire heat generated in the time period, the more the upper temperature limit, at which the cooling device is activated, is shifted in the direction of a lower temperature at the end of a certain time period Δt.

The two temperature limits T_{oG} and T_{uG} may also be varied as a function of the vehicle operating data that is stored. For example, the ambient temperature of the vehicle, referred to herein as T_{U}(t), can be measured as a function of time with a temperature sensor. If the ambient temperature deviates from a predetermined reference temperature T_{ref}, the upper temperature limit is changed in accordance with ΔT_{oG}∝−(T_{U}(t)−T_{ref}); and/or the lower temperature limit is changed in accordance with ΔT_{uG}∝−(T_{U}(t)−T_{ref}). Therefore, if the ambient temperature exceeds the reference temperature, the temperature limits are adjusted in the direction of the smaller temperature values. If the ambient temperature is below the reference temperature, then an adjustment is made in the direction of a higher temperature. If only one of the two temperature limits is changed, then the temperature hysteresis, which results from the temperature difference between the upper temperature limit T_{oG} and the lower temperature limit T_{uG}, can be changed. For example, the energy storage device can be precooled in the case of a warm ambient temperature for a stationary phase following the trip by shifting the lower temperature limit T_{uG} in the direction of the lower temperature.

For this purpose the vehicle operating data may include, in addition to the ambient temperature, the profile of a route that will come up next at time t. The route to be travelled can be calculated, for example, by a GPS navigation system. The characteristic features of an upcoming trip can be used by the temperature control method as an input variable. A characteristic feature of a route to be travelled is, for example, a cluster of curves or slopes. In addition to the route data, additional information can be received by way of a communication system, for example via a GSM connection. This additional information includes, for example, reports on the traffic conditions. Data on the current traffic condition can complement the route data in a useful way. For example, frequent startup and braking actions can be expected along a route with a high volume of traffic or congestion. If one knows the number of curves, the frequency of slopes to be encountered during a trip or in stop and go traffic, it is possible to estimate at least roughly the expected heat loss ∫ₜ^{t+Δt}Pᵥ(t)dt, where Δt stands for an upcoming time interval, and Pᵥ(t) stands for a prognosticated power dissipation from the current time t to a future time t+Δt. When the heat loss is expected to be high, the upper temperature limit can be adjusted, for example, in accordance with ΔT_{oG}∝−∫ₜ^{t+Δt}Pᵥ(t)dt. This means that for a prediction of high power dissipation, the cooling device is activated ∂ₜ a reduced switch-on temperature.

Moreover, weather information can also be received by way of the communication system of the vehicle and can be used as a parameter for shifting the temperature limits. The development of the weather situation along the next upcoming route to be travelled can influence the development of heat ∫ₜ^{t+Δt}Pᵥ(t)dt that takes place in the energy storage device and that is based on the prognosis of the power dissipation. Because of the expected ambient temperature it is possible to assume, for example, an improvement in the indirect cooling of the energy storage device in the installation space, if the trip leads, for example, into colder air layers of higher altitude. When the temperature limits are shifted, such an effect can be considered, for example, by a weather weighting factor g_{w} in g_{w}·∫ₜ^{t+Δt}Pᵥ(t)dt. In the described case with improved cooling, the weighting factor g_{w} can be a value between 0 and 1, so that a shift of the temperature limit in the direction of a lower temperature according to ΔT_{oG}∝−g_{w}·∫ₜ^{t+Δt}Pᵥ(t)dt can be attenuated in a targeted way.

A similar procedure can be implemented, if the typical features of the driving pattern of a particular driver are known. A particular driver may be identified by the vehicle, for example through the use of an electronic vehicle key, which is assigned exclusively to the driver or through manual input or voice input at the driver's work station. During the trip of a particular driver diverse data items, from which the driving profile of the driver can be inferred, may be recorded and evaluated. Such data items could be, for example, the acceleration values, the pedal positions or the currents of the energy storage device. As the number of trips of a particular driver increases, it may be possible to recognize the characteristic features of the driver's driving pattern. These features, such as frequent driving maneuvers at maximum vehicle traction, may prove to be unfavorable for the temperature development of the energy storage device. If a particular driver is identified by the vehicle before embarking on an upcoming route, the driving profile of said driver may be taken into account in the form of an additional weighting factor, namely the driver weighting factor g_{F}, in the course of controlling the temperature of the energy storage device. For example, in the case of a driver, for whom a high heat input into the energy storage device can be expected, a shift of the upper temperature limit in the direction of the lower temperature according to ΔT_{oG}∝−g_{F}·g_{w}·∫ₜ^{t+Δt}Pᵥ(t)dt can be reinforced. In this case, the weighting factor g_{w} is set to greater than 1.

The temperature limits T_{oG} and T_{uG} can be varied, for example, at periodic time intervals or when significant changes are made in the time-dependent energy storage device data or the vehicle operating data.

1.-8. (canceled)

9. A temperature control method for an electrochemical energy storage device in a vehicle, wherein the electrochemical energy storage device has a cooling device for cooling said electrochemical energy storage device, and wherein an actual temperature value of the electrochemical energy storage device is determined, and a desired temperature value of the electrochemical energy storage device is set via a two-point control system, the method comprising the acts of:
defining an upper temperature limit of the two-point control system and/or a lower temperature limit of the two-point control system as a function of time during operation of the electrochemical energy storage device or during activation of the cooling device, wherein
the upper temperature limit of the two-point control system and/or the lower temperature limit of the two-point control system are defined as a function of energy storage device data and/or vehicle operating data;
activating the cooling device at the upper temperature limit of the electrochemical energy storage device and deactivating the cooling device at the lower temperature limit of the electrochemical energy storage device.

10. The temperature control method according to claim 9, further comprising the acts of:
storing the energy storage device data and the vehicle operating data at least on a control device of the vehicle or a storage medium of the vehicle;
determining the energy storage device data and the vehicle operating data via at least one of (i) measurements in the vehicle, (ii) calculations performed by a control device, (iii) simulations performed by the control device, and (iv) signals received from a communication system of the vehicle; and
using the energy storage device data and the vehicle operating data as input variables of the temperature control method.

11. The temperature control method according to claim 9, wherein:
the energy storage device data comprise a record of the actual temperature value of the electrochemical energy storage device as a function of time,
a time-dependent temperature gradient is determined from the record of the actual temperature value, and
the upper temperature limit of the two-point control system and/or the lower temperature limit of the two-point control system are defined as a function of the time-dependent temperature gradient.

12. The temperature control method according to claim 10, wherein:
the energy storage device data comprise a record of the actual temperature value of the electrochemical energy storage device as a function of time,
a time-dependent temperature gradient is determined from the record of the actual temperature value, and
the upper temperature limit of the two-point control system and/or the lower temperature limit of the two-point control system are defined as a function of the time-dependent temperature gradient.

13. The temperature control method according to claim 9, wherein:
the energy storage device data comprise a time-dependent record of charge current and discharge current of the electrochemical energy storage device and a time-dependent record of voltage of the electrochemical energy storage device,
a time-dependent relative state of charge of the electrochemical energy storage device is determined from the record of the current and the record of the voltage, and
the upper temperature limit of the two-point control system and/or the lower temperature limit of the two-point control system are defined as a function of the time-dependent relative state of charge.

14. The temperature control method according to claim 13, wherein:
a time-dependent internal resistance of the electrochemical energy storage device is determined from the record of the current and from the record of the voltage, and
the upper temperature limit of the two-point control system and/or the lower temperature limit of the two-point control system are defined as a function of the time-dependent internal resistance.

15. The temperature control method according to claim 9, wherein:
the vehicle operating data comprise a time-dependent record of an ambient temperature of the vehicle, and
the upper temperature limit of the two-point control system and/or the lower temperature limit of the two-point control system are defined as a function of the ambient temperature.

16. The temperature control method according to claim 11, wherein:
the vehicle operating data comprise a time-dependent record of an ambient temperature of the vehicle, and
the upper temperature limit of the two-point control system and/or the lower temperature limit of the two-point control system are defined as a function of the ambient temperature.

17. The temperature control method according to claim 9, wherein:
the vehicle operating data comprise the route profile of an upcoming route that is determined by a navigation system of the vehicle,
the vehicle operating data comprise information about a traffic situation along the upcoming route to be travelled, said information being received from a communication device of the vehicle,
the vehicle operating data comprise information about a weather forecast at a location of the vehicle and along the upcoming route to be travelled, both of said types of information are received from a communication system of the vehicle, and
the upper temperature limit of the two-point control system and/or the lower temperature limit of the two-point control system are defined as a function of characteristic features of the route profile, the traffic situation and/or the weather forecast.

18. The temperature control method according to claim 16, wherein:
the vehicle operating data comprise the route profile of an upcoming route that is determined by a navigation system of the vehicle,
the vehicle operating data comprise information about a traffic situation along the upcoming route to be travelled, said information being received from a communication device of the vehicle,
the vehicle operating data comprise information about a weather forecast at a location of the vehicle and along the upcoming route to be travelled, both if said types of information are received from a communication system of the vehicle, and
the upper temperature limit of the two-point control system and/or the lower temperature limit of the two-point control system defined as a function of characteristic features of the route profile, the traffic situation and/or the weather forecast.

19. The temperature control method according to claim 9, wherein:
the vehicle operating data comprise information about a user behavior that characterizes a particular driver of the vehicle, wherein the driver is identified by an identification device in the vehicle,
the user behavior of a particular driver is determined from one of (i) a record of a charge current and a discharge current of the electrochemical energy storage device over a long observation period, and (ii) a record of acceleration values and deceleration values of the vehicle over a long observation period, and
the upper temperature limit of the two-point control system and/or the lower temperature limit of the two-point control system are defined as a function of the characteristic features of the user behavior of a particular driver.

20. The temperature control method according to claim 18, wherein:
the vehicle operating data comprise information about a user behavior that characterizes a particular driver of the vehicle, wherein the driver is identified by an identification device in the vehicle,
the user behavior of a particular driver is determined from one of (i) a record of a charge current and a discharge current of the electrochemical energy storage device over a long observation period, and (ii) a record of acceleration values and deceleration values of the vehicle over a long observation period, and
the upper temperature limit of the two-point control system and/or the lower temperature limit of the two-point control system are defined as a function of the characteristic features of the user behavior of a particular driver.
